(19) United States
(12) Patent Application Publication
(10) Pub. No.: US 2015/0324892 A1
(43) Pub. Date: Nov. 12, 2015

(54) CONTENT-BASED MARKETPLACE

(71) Applicants: Mike Matousek, Boston, MA (US); David Petruziello, South Euclid, OH (US)

(72) Inventors: Mike Matousek, Boston, MA (US); David Petruziello, South Euclid, OH (US)

(21) Appl. No.: 13/877,632

(22) PCT Filed: Oct. 4, 2011
(86) PCT No.: PCT/US2011/054796

§ 371 Date: Aug. 26, 2013

Related U.S. Application Data
(60) Provisional application No. 61/389,620, filed on Oct. 4, 2010.
(60) Provisional application No. 61/506,781, filed on Jul. 12, 2011.

(51) Int. Cl. G06Q 30/06; G06F 17/30

(52) U.S. Cl. CPC G06Q 30/0635; G06F 17/30864; G06F 17/30893

(57) ABSTRACT

The present invention generally relates to a content-based marketplace that is designed to provide a place for individuals to post, market and sell user created content. In one embodiment, the present invention is a web-based content marketplace that permits a user to post, market and sell user created content. In another embodiment, the present invention is a web-based content marketplace that permits a user to post, market and sell user created content, as well as a web-based rating service the permits potential buyers to rate user generated content. In still another embodiment, the present invention is a web-based content marketplace for class notes that permits a user to post, market and sell user created content, as well as a web-based rating service the permits both potential buyers to rate user generated class note content and content generators to rate a professor and/or class.

### RELATED APPLICATION DATA

This patent application claims priority to U.S. Provisional Patent Application No. 61/389,620 filed Oct. 4, 2010 and entitled “Content-Based Marketplace” and to U.S. Provisional Patent Application No. 61/506,781 filed Jul. 12, 2011 and entitled “Content-Based Marketplace,” the entireties of which are both incorporated herein by reference.

### FIELD OF THE INVENTION

The present invention generally relates to a content-based marketplace that is designed to provide a place for individuals to post, market and sell user created content. In one embodiment, the present invention is a web-based content marketplace that permits a user to post, market and sell user created content. In another embodiment, the present invention is a web-based content marketplace that permits a user to post, market and sell user created content, as well as a web-based rating service the permits potential buyers to rate user generated content. In still another embodiment, the present invention is a web-based content marketplace for class notes that permits a user to post, market and sell user created content, as well as a web-based rating service the permits both potential buyers to rate user generated class note content and content generators to rate a professor and/or a class.

### BACKGROUND OF THE INVENTION

Class attendance at various levels of education can be problematic for a variety of reasons. For example, a temporary illness can cause one to miss a number of class lectures. Alternatively, a family matter, or other activity, can cause a student to miss multiple class lectures. When one misses one or more classroom lectures there are few choices for attempting to recover lost lecture notes from such class lectures. One potential solution is to ask a friend from class. However, this is problematic because in some classes the person missing may not “know” someone well enough to feel comfortable asking for notes. In another instance, the class may be graded on a curve which can cause internal competition and thus dissuade follow class takers from sharing. Still another issue may be that the person who misses does not like the work product of any one or more of their friends in the class.

Accordingly, in light of the above, there is a need in the art for a system that permits a class attendee to obtain lecture notes, or other class related content, from a follow class taker, or former class taker.

### SUMMARY OF THE INVENTION

The present invention generally relates to a content-based marketplace that is designed to provide a place for individuals to post, market and sell user created content. In one embodiment, the present invention is a web-based content marketplace that permits a user to post, market and sell user created content. In another embodiment, the present invention is a web-based content marketplace that permits a user to post, market and sell user created content, as well as a web-based rating service the permits potential buyers to rate user generated content. In still another embodiment, the present invention is a web-based content marketplace for class notes that permits a user to post, market and sell user created content, as well as a web-based rating service the permits both potential buyers to rate user generated class note content and content generators to rate a professor and/or a class.

In one embodiment, the present invention relates to a system for permitting the posting of user generated content including, but not limited to, class-/lecture-related user generated content as shown and described herein.

In another embodiment, the present invention relates to a method for permitting the posting of user generated content including, but not limited to, class-/lecture-related user generated content as shown and described herein.

In still another embodiment, the present invention relates to a system for permitting the transfer of user generated content including, but not limited to, class-/lecture-related user generated content as shown and described herein.

In still yet another embodiment, the present invention relates to a method for permitting the transfer of user generated content including, but not limited to, class-/lecture-related user generated content as shown and described herein.

In still another embodiment, the present invention relates to a system for permitting the posting of user generated content to the World Wide Web, the system comprising: at least one web-enabled electronic device; at least one program application, wherein the program application is designed to run on the at least one web-enabled electronic device and access the World Wide Web therefrom; at least one user created data packet, wherein the at least one user created data packet is located in the memory at least one web-enabled electronic device or is electronically accessible to the at least one web-enabled electronic device; and at least one World Wide Web site designed to receive the at least one user created data packet, wherein the at least one World Wide Web site is designed to permit searching of all of the user created data packets thereon by one or more criteria selected from author's name, subject matter, class name, class number, class section number, professor's name, college, ISBN number, text book title, text book author's name, text book editor's name, text book publisher, or any two or more thereof.

In still another embodiment, the present invention relates to a method for permitting the posting of user generated content to the World Wide Web, the method comprising the steps of: providing at least one web-enabled electronic device; providing at least one program application, wherein the program application is designed to run on the at least one web-enabled electronic device and access the World Wide Web therefrom; providing at least one World Wide Web site designed to receive at least one user created data packet, wherein the at least one World Wide Web site is designed to permit searching of all of the user created data packets thereon by one or more criteria selected from author's name, subject matter, class name, class number, class section number, professor's name, college, ISBN number, text book title, text book author's name, text book editor's name, text book publisher, or any two or more thereof; accessing the at least one World Wide Web site via the at least one web-enabled electronic device; and posting at least one user created data packet to the at least one World Wide Web site, wherein the at least one user created data packet is located in the memory at least one web-enabled electronic device or is electronically accessible to the at least one web-enabled electronic device.

In still another embodiment, the present invention relates to a system for permitting the transfer and/or purchase of user generated content to the World Wide Web, the system comprising: at least one web-enabled electronic device; at least one program application, wherein the program application is designed to run on the at least one web-enabled electronic device and access the World Wide Web therefrom; at least one user created data packet, wherein the at least one user created data packet is located in the memory at least one web-enabled electronic device or is electronically accessible to the at least one web-enabled electronic device; and at least one World Wide Web site designed to receive, store and transfer the at least one user created data packet, wherein the at least one World Wide Web site is designed to permit searching of all of the user created data packets thereon by one or more criteria selected from author's name, subject matter, class name, class number, class section number, professor's name, college, ISBN number, text book title, text book author's name, text book editor's name, text book publisher, or any two or more thereof, wherein the at least one World Wide Web site further comprises a payment processing system designed to process payments for the at least one user created data packet and a system for permitting the transfer of the user created data packet to at least one purchaser.

In still another embodiment, the present invention relates to a method for permitting the transfer and/or purchase of user generated content to the World Wide Web, the method comprising the steps of: providing at least one web-enabled electronic device; providing at least one program application, wherein the program application is designed to run on the at least one web-enabled electronic device and access the World Wide Web therefrom; providing at least one World Wide Web site designed to receive at least one user created data packet, wherein the at least one World Wide Web site is designed to permit searching of all of the user created data packets thereon by one or more criteria selected from author's name, subject matter, class name, class number, class section number, professor's name, college, ISBN number, text book title, text book author's name, text book editor's name, text book publisher, or any two or more thereof; accessing the at least one World Wide Web site via the at least one web-enabled electronic device; searching the one or more user created data packets; and purchasing at least one or more user created data packets.

### BRIEF DESCRIPTION OF THE DRAWINGS

FIG. 1 is a flow chart illustrating one embodiment of the present invention based on the steps utilized by a content generator; and

FIG. 2 is a flow chart illustrating one embodiment of the present invention based on the steps utilized by a content purchaser.

### DETAILED DESCRIPTION OF THE INVENTION

The present invention generally relates to a content-based marketplace that is designed to provide a place for individuals to post, market and sell user created content. In one embodiment, the present invention is a web-based content marketplace that permits a user to post, market and sell user created content. In another embodiment, the present invention is a web-based content marketplace that permits a user to post, market and sell user created content, as well as a web-based rating service the permits potential buyers to rate user generated content. In still another embodiment, the present invention is a web-based content marketplace for class notes that permits a user to post, market and sell user created content, as well as a web-based rating service the permits both potential buyers to rate user generated class note content and content generators to rate a professor and/or a class.

In one embodiment, the present invention relates to a content-based marketplace that is designed to provide a place for individuals to post, market and sell user created content. In this embodiment, the present invention permits a user to create an account and then post a wide variety of use created content. Such content can include, but is not limited to, class notes, lecture notes, lab notes, lab data, class related diagrams and/or pictures, user generated study guides, etc. In this embodiment, the user generated content can take any of a variety of file formats. Such formats include, but are not limited to, PDF files, Word files, WordPerfect files, any other word processing format, gif files/images, jpeg files/images, tiff files/images, etc. As would be apparent to those of skill in the art, if the user in question is a repeat user the step of creating an account is not necessary and instead the returning user signs in to access their account. Given the above, the present invention permits a user to generate content and then post, market and sell such content. A sales price is, in one embodiment, determined by the user. When a sale occurs some portion, or even no portion thereof, of the sales price is retained by the marketplace provider as a fee for maintain, running and advertising the content-based market place.

In one embodiment, the marketplace provider retains at least about 5 percent, at least about 10 percent, at least about 15 percent, at least about 20 percent, at least about 25 percent, at least about 30 percent, at least about 35 percent, at least about 40 percent, at least about 45 percent, or even about 50 percent of the sales price that is determined/set by the user/content creator, with the remainder being retained/given/forwarded to the user/content generator. In another embodiment, the more frequently a user posts content and makes sales such a user acquires a preferred status that can be rewarded by an increase in the amount of the sales price retained/given/forwarded to the user/content generator. Here, as well as elsewhere in the specification and claims, individual range values and/or limits can be combined to form additional and/or non-disclosed ranges.

In one embodiment, payments are conducted by an electronic payment system with the user/content generator being credited their portion electronically. Suitable payment systems include, but are not limited to, web-based payment devices (e.g., PayPal, etc.), credit cards, wire transfers, electronic checks, etc.

In one instance, the market place in this embodiment permits the user/content generator to catalogue/file their work based upon the nature of the content posted. For example, such cataloguing/filing can be accomplished by subject matter, content, class, professor, content type, etc.

In another embodiment, the present invention is a web-based content marketplace that permits a user to post, market and sell user created content, as well as a web-based rating service the permits potential buyers to rate user generated content. In this embodiment, the present invention permits a user to create an account and then post a wide variety of use created content. Such content can include, but is not limited to, class notes, lecture notes, lab notes, lab data, class related diagrams and/or pictures, user generated study guides, etc. In this embodiment, the user generated content can take any of a variety of file formats. Such formats include, but are not limited to, PDF files, Word files, WordPerfect files, any other word processing format, gif files/images, jpeg files/images, tiff files/images, etc. As would be apparent to those of skill in the art, if the user in question is a repeat user the step of creating an account is not necessary and instead the returning user signs in to access their account. Given the above, the present invention permits a user to generate content and then post, market and sell such content. A sales price is, in one embodiment, determined by the user. When a sale occurs some portion, or even no portion thereof, of the sales price is retained by the marketplace provider as a fee for maintain, running and advertising the content-based market place.

In this embodiment, the marketplace provider retains at least about 5 percent, at least about 10 percent, at least about 15 percent, at least about 20 percent, at least about 25 percent, at least about 30 percent, at least about 35 percent, at least about 40 percent, at least about 45 percent, or even about 50 percent of the sales price that is determined/set by the user/content creator, with the remainder being retained/given/forwarded to the user/content generator. In another embodiment, the more frequently a user posts content and makes sales such a user acquires a preferred status that can be rewarded by an increase in the amount of the sales price retained/given/forwarded to the user/content generator. Here, as well as elsewhere in the specification and claims, individual range values and/or limits can be combined to form additional and/or non-disclosed ranges.

In this embodiment, payments are conducted by an electronic payment system with the user/content generator being credited their portion electronically. Suitable payment systems include, but are not limited to, web-based payment devices (e.g., PayPal, etc.), credit cards, wire transfers, electronic checks, etc.

In one instance, the market place in this embodiment permits the user/content generator to catalogue/file their work based upon the nature of the content posted. For example, such cataloguing/filing can be accomplished by subject matter, content, class, professor, content type, etc. Additionally, in this embodiment, the web-based marketplace permits a user to critique a variety of aspects associated with the class, lecture, etc. that is the basis for the content being generated by the user. Such aspects which can be critiqued are the professor's teaching skills, the content of the class and/or lecture, the desirability and/or worth of the class and/or lecture, etc.

In still another embodiment, the present invention is a web-based content marketplace for class notes that permits a user to post, market and sell user created content, as well as a web-based rating service the permits both potential buyers to rate user generated class note content and content generators to rate a professor and/or a class.

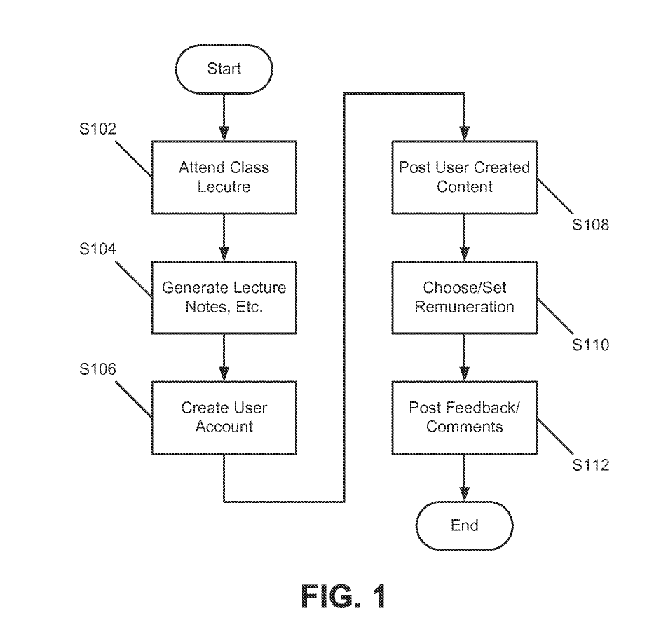

Turning to the Figures, FIG. 1 depicts the various steps, some optional, that a user/content generator would undertake to utilize a web-based content marketplace. In S102 a prospective user (at least at this juncture since the user/content generator has not yet posted material) attends a class, lecture, etc. in which the prospective user generates various class/lecture related content (S104). In S106 a prospective user, or a repeat user, accesses the web site for the web-based content marketplace. As would be apparent to one of skill in the art, such a web site could be accessed from any type of electronic device that has available an Internet connection. Such devices include, but are not limited to, computers, cell phones, tablet computers, web access devices, Internet ready appliances (e.g., Internet ready televisions), etc. In S106, if need be, the user creates an account. Such an account permits the user to: (i) track various aspects of their account; (ii) set up payment options; (iii) post content; (iv) permit receipt of payment for any content that is sold; (v) post comments about the classes/lectures; and/or (vi) purchase content from other users/content generators. As would be apparent to those of skill in the art, not all of the above features will be utilized by every user. In fact some users may only utilize one of the above features.

Turning to S108, the user decides to post one or more pieces of user generated content on the web based market place. Such content can, if so desired, be cross-referenced by one or more indicia. Such indicia includes, but is not limited to, class name, section number, professor name, college, text book indicia (e.g., text book indicia includes, but is not limited to, one or more of the following: ISBN number, text book title, text book author and/or editor, text book publisher, etc.), etc. In S110, the user/content generator sets a remuneration level for their posted work. Such a level can be for the whole work, or any part thereof. Additionally, depending upon the frequency of use, the user/content generator is advised of the split of the remuneration between the user/content generator and the web-based marketplace provider. In one instance, the remuneration is money. Although, the present invention is not limited solely to this embodiment and other types of remuneration can be utilized. For example, alternative non-monetary based remuneration can be utilized. Such remuneration could include, but is not limited to, gift certificates, points towards purchases on the web-based marketplace, etc.

In S112, which is optional, the web-based marketplace permits users/content generators to leave feedback/comments relating to the classes, lectures, etc. which form the basis for the user generated content that is being posted. Such comments can be a review of a professor/teacher/lecturer, a review of a class/lecture, or even a review of the content/worth of a certain class/lecture.

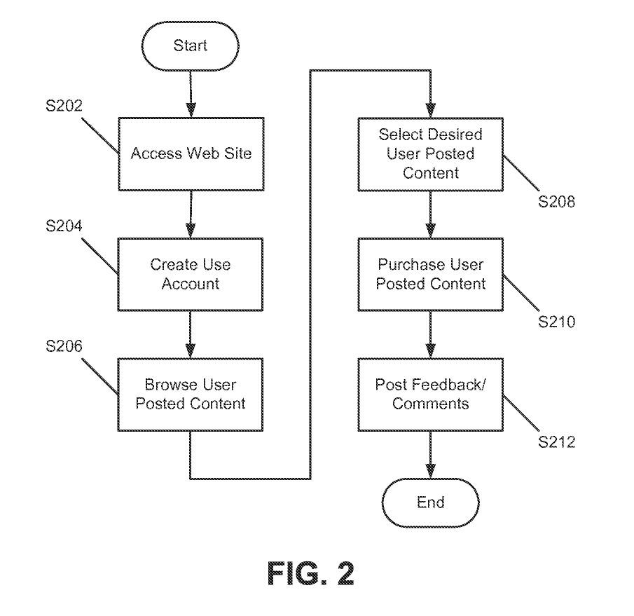

Turning to FIG. 2, FIG. 2 depicts the various steps, some optional, that a user/content purchaser would undertake to utilize a web-based content marketplace. In S202 a prospective user/purchaser (at least at this juncture since the user/content purchaser has not yet posted material), or a repeat user/content purchaser, accesses the web site for the web-based content marketplace. As would be apparent to one of skill in the art, such a web site could be accessed from any type of electronic device that has available an Internet connection. Such devices include, but are not limited to, computers, cell phones, tablet computers, web access devices, Internet ready appliances (e.g., Internet ready televisions), etc. In S204, if need be, the user/content purchaser creates an account. Such an account permits the user to: (i) track various aspects of their account; (ii) set up payment options; (iii) purchase content; (iv) make payments for any content that is purchased; (v) post comments about the quality or the details of the content purchased (including a review of the content if so desired); and/or (vi) if so desired post their own content for sake. As would be apparent to those of skill in the art, not all of the above features will be utilized by every user. In fact some users may only utilize one of the above features.

Turning to S206, the user/content purchaser is able to browse the content located on the web-based content marketplace by school, class, section, professor, poster/content creator, etc. In S208, if so desired, the user/content purchaser selects one or more items to purchase. In conjunction with this, a payment type is selected. In one embodiment, payment can be made by electronic fund transfer, credit card, bank card, electronic payment services (e.g., PayPal, etc.).

In S210, which is optional, the web-based marketplace permits users/content purchasers to leave feedback/comments relating to the content that is purchased. Such comments can be a review of the content, the content generator, or any other pertinent fact relating to the content purchased.

In still another embodiment, the present invention is a web-based content social media marketplace for class notes that permits a user to post, market and sell user created content that utilizes social media communications tools and techniques to inform buyers of content as to the availability of the content.

Furthermore, in any of the above embodiments, the present invention can also capture various school reference data. In this embodiment, the such a web-based content marketplace is designed/able to automatically search and compile various data contained on one or more websites (e.g., school websites) thereby permitting the capture of student-based reference information (e.g., schedules, updates, changes, calendars, professor profiles, etc.). Such compiled, or captured data, can then be utilized by the site to offer a tailored interface for a respective school.

In another instance, the present invention is directed to a content-based marketplace that permits any number of individuals to post, sell, buy and/or trade one or more lecture's worth of class notes. In one embodiment, any class notes on the content-based marketplace can be searched by one or more search criteria. Suitable search criteria includes, but is not limited to, class name, section number, professor name, college, text book indicia (e.g., text book indicia includes, but is not limited to, one or more of the following: ISBN number, text book title, text book author and/or editor, text book publisher, etc.), etc. In one instance, the search criteria is the text book ISBN number from the text book that is utilized in conjunction with class in question. Thus, in this embodiment, students from different schools can utilize each other's class notes based on the fact that such students are utilizing the same text book (which can be confirmed through the use of an ISBN number system), regardless of the school attended by the note taker and the note purchaser.

In still another embodiment, the content-based marketplace of the present invention generates a post, or tweet, to a user's Facebook or Twitter account when such a user posts new notes and/or sells notes to a purchaser. In another embodiment, a user can access their account via a computer-based app for a portable Internet device.

Given the above, in one embodiment the present invention relates to a system for permitting the posting of user generated content to the World Wide Web, the system comprising: at least one web-enabled electronic device; at least one program application, wherein the program application is designed to run on the at least one web-enabled electronic device and access the World Wide Web therefrom; at least one user created data packet, wherein the at least one user created data packet is located in the memory at least one web-enabled electronic device or is electronically accessible to the at least one web-enabled electronic device; and at least one World Wide Web site designed to receive the at least one user created data packet, wherein the at least one World Wide Web site is designed to permit searching of all of the user created data packets thereon by one or more criteria selected from author's name, subject matter, class name, class number, class section number, professor's name, college, ISBN number, text book title, text book author's name, text book editor's name, text book publisher, or any two or more thereof.

In one embodiment, in the above system the at least one web-enabled electronic device is selected from a computer, a tablet, a cell phone, a personal digital assistant (PDA), or a WI-FI enabled device. In one embodiment, in the above system the at least one program application is selected from a web browser, an Apple application, an Android application, or a combination of two or more thereof. In one embodiment, in the above system the at least one user created data packet is selected from PDF files, word processing files, gif files/images, jpeg files/images, tiff files/images, or a combination of two or more thereof. In one embodiment, in the above system the at least one user created data packet is selected from class notes, lecture notes, lab notes, lab data, class related diagrams and/or pictures, user generated study guides or outlines, or a combination of two or more thereof.

In one embodiment, in the above system the at least one user created data packet is selected from class notes, lecture notes, lab notes, lab data, class related diagrams and/or pictures, user generated study guides or outlines, or a combination of two or more thereof. In one embodiment, in the above system the at least one World Wide Web site is designed to receive the at least one user created data packet further comprises a purchase system designed to permit an individual to purchase one or more user created data packets from the at least one World Wide Web site.

In one embodiment, in the above system the at least one World Wide Web site retains at least about 5 percent of a pre-set sale price that is set by the user/content creator with the remainder being forwarded to the user/content creator. In one embodiment, in the above system the at least one World Wide Web site retains at least about 10 percent of a pre-set sale price that is set by the user/content creator with the remainder being forwarded to the user/content creator. In one embodiment, in the above system the at least one World Wide Web site retains at least about 15 percent of a pre-set sale price that is set by the user/content creator with the remainder being forwarded to the user/content creator. In one embodiment, in the above system the at least one World Wide Web site retains at least about 20 percent of a pre-set sale price that is set by the user/content creator with the remainder being forwarded to the user/content creator. In one embodiment, in the above system the at least one World Wide Web site retains at least about 25 percent of a pre-set sale price that is set by the user/content creator with the remainder being forwarded to the user/content creator.

In one embodiment, in the above system the at least one World Wide Web site is designed to receive the at least one user created data packet further comprises a notification system designed to notify one or more individuals when one or more one user created data packets are posted to the at least one World Wide Web site. In one embodiment, in the above system the notification occurs via Twitter, Facebook, MySpace, or a combination of two or more thereof.

Given the above, in another embodiment the present invention relates to a method for permitting the posting of user generated content to the World Wide Web, the method comprising the steps of: providing at least one web-enabled electronic device; providing at least one program application, wherein the program application is designed to run on the at least one web-enabled electronic device and access the World Wide Web therefrom; providing at least one World Wide Web site is designed to receive at least one user created data packet, wherein the at least one World Wide Web site is designed to permit searching of all of the user created data packets thereon by one or more criteria selected from author's name, subject matter, class name, class number, class section number, professor's name, college, ISBN number, text book title, text book author's name, text book editor's name, text book publisher, or any two or more thereof; accessing the at least one World Wide Web site via the at least one web-enabled electronic device; and posting at least one user created data packet to the at least one World Wide Web site, wherein the at least one user created data packet is located in the memory at least one web-enabled electronic device or is electronically accessible to the at least one web-enabled electronic device.

In one embodiment, in the above system the at least one web-enabled electronic device is selected from a computer, a tablet, a cell phone, a personal digital assistant (PDA), or a WI-FI enabled device. In one embodiment, in the above system the at least one program application is selected from a web browser, an Apple application, an Android application, or a combination of two or more thereof. In one embodiment, in the above system the at least one user created data packet is selected from PDF files, word processing files, gif files/images, jpeg files/images, tiff files/images, or a combination of two or more thereof. In one embodiment, in the above system the at least one user created data packet is selected from class notes, lecture notes, lab notes, lab data, class related diagrams and/or pictures, user generated study guides or outlines, or a combination of two or more thereof.

In one embodiment, in the above system the at least one user created data packet is selected from class notes, lecture notes, lab notes, lab data, class related diagrams and/or pictures, user generated study guides or outlines, or a combination of two or more thereof. In one embodiment, in the above system further comprises the step of: setting a sale price for the at least one user created data packet, wherein the sale prices is determined by the user/content creator. In one embodiment, in the above system the at least one World Wide Web site is designed to receive the at least one user created data packet further comprises a purchase system designed to permit an individual to purchase one or more user created data packets from the at least one World Wide Web site. In one embodiment, in the above system the at least one World Wide Web site retains at least about 5 percent of the pre-set sale price that is set by the user/content creator with the remainder being forwarded to the user/content creator. In one embodiment, in the above system the at least one World Wide Web site retains at least about 10 percent of the pre-set sale price that is set by the user/content creator with the remainder being forwarded to the user/content creator.

In one embodiment, in the above system the at least one World Wide Web site retains at least about 15 percent of the pre-set sale price that is set by the user/content creator with the remainder being forwarded to the user/content creator. In one embodiment, in the above system the at least one World Wide Web site retains at least about 20 percent of the pre-set sale price that is set by the user/content creator with the remainder being forwarded to the user/content creator. In one embodiment, in the above system the at least one World Wide Web site retains at least about 25 percent of the pre-set sale price that is set by the user/content creator with the remainder being forwarded to the user/content creator. In one embodiment, in the above system the at least one World Wide Web site is designed to receive the at least one user created data packet further comprises a notification system designed to notify one or more individuals when one or more one user created data packets are posted to the at least one World Wide Web site. In one embodiment, in the above system the notification occurs via Twitter, Facebook, MySpace, or a combination of two or more thereof.

Given the above, in still another embodiment the present invention relates to a system for permitting the transfer and/or purchase of user generated content to the World Wide Web, the system comprising: at least one web-enabled electronic device; at least one program application, wherein the program application is designed to run on the at least one web-enabled electronic device and access the World Wide Web therefrom; at least one user created data packet, wherein the at least one user created data packet is located in the memory at least one web-enabled electronic device or is electronically accessible to the at least one web-enabled electronic device; and at least one World Wide Web site is designed to receive, store and transfer the at least one user created data packet, wherein the at least one World Wide Web site is designed to permit searching of all of the user created data packets thereon by one or more criteria selected from author's name, subject matter, class name, class number, class section number, professor's name, college, ISBN number, text book title, text book author's name, text book editor's name, text book publisher, or any two or more thereof, wherein the at least one World Wide Web site further comprises a payment processing system designed to process payments for the at least one user created data packet and a system for permitting the transfer of the user created data packet to at least one purchaser.

In one embodiment, in the above system the at least one web-enabled electronic device is selected from a computer, a tablet, a cell phone, a personal digital assistant (PDA), or a WI-FI enabled device. In one embodiment, in the above system the at least one program application is selected from a web browser, an Apple application, an Android application, or a combination of two or more thereof. In one embodiment, in the above system the at least one user created data packet is selected from PDF files, word processing files, gif files/images, jpeg files/images, tiff files/images, or a combination of two or more thereof. In one embodiment, in the above system the at least one user created data packet is selected from class notes, lecture notes, lab notes, lab data, class related diagrams and/or pictures, user generated study guides or outlines, or a combination of two or more thereof. In one embodiment, in the above system the at least one user created data packet is selected from class notes, lecture notes, lab notes, lab data, class related diagrams and/or pictures, user generated study guides or outlines, or a combination of two or more thereof.

In one embodiment, in the above system the at least one World Wide Web site is designed to receive the at least one user created data packet further comprises a purchase system designed to permit an individual to purchase one or more user created data packets from the at least one World Wide Web site. In one embodiment, in the above system the at least one World Wide Web site retains at least about 5 percent of a pre-set sale price that is set by the user/content creator with the remainder being forwarded to the user/content creator. In one embodiment, in the above system the at least one World Wide Web site retains at least about 10 percent of a pre-set sale price that is set by the user/content creator with the remainder being forwarded to the user/content creator. In one embodiment, in the above system the at least one World Wide Web site retains at least about 15 percent of a pre-set sale price that is set by the user/content creator with the remainder being forwarded to the user/content creator.

In one embodiment, in the above system the at least one World Wide Web site retains at least about 20 percent of a pre-set sale price that is set by the user/content creator with the remainder being forwarded to the user/content creator. In one embodiment, in the above system the at least one World Wide Web site retains at least about 25 percent of a pre-set sale price that is set by the user/content creator with the remainder being forwarded to the user/content creator. In one embodiment, in the above system the at least one World Wide Web site is designed to receive the at least one user created data packet further comprises a notification system designed to notify one or more individuals when one or more one user created data packets are posted to the at least one World Wide Web site. In one embodiment, in the above system the notification occurs via Twitter, Facebook, MySpace, or a combination of two or more thereof.

Given the above, in still another embodiment the present invention relates to a method for permitting the transfer and/or purchase of user generated content to the World Wide Web, the method comprising the steps of: providing at least one web-enabled electronic device; providing at least one program application, wherein the program application is designed to run on the at least one web-enabled electronic device and access the World Wide Web therefrom; providing at least one World Wide Web site is designed to receive at least one user created data packet, wherein the at least one World Wide Web site is designed to permit searching of all of the user created data packets thereon by one or more criteria selected from author's name, subject matter, class name, class number, class section number, professor's name, college, ISBN number, text book title, text book author's name, text book editor's name, text book publisher, or any two or more thereof; accessing the at least one World Wide Web site via the at least one web-enabled electronic device; searching the one or more user created data packets; and purchasing at least one or more user created data packets.

In one embodiment, in the above system the at least one web-enabled electronic device is selected from a computer, a tablet, a cell phone, a personal digital assistant (PDA), or a WI-FI enabled device. In one embodiment, in the above system the at least one program application is selected from a web browser, an Apple application, an Android application, or a combination of two or more thereof. In one embodiment, in the above system the at least one user created data packet is selected from PDF files, word processing files, gif files/images, jpeg files/images, tiff files/images, or a combination of two or more thereof. In one embodiment, in the above system the at least one user created data packet is selected from class notes, lecture notes, lab notes, lab data, class related diagrams and/or pictures, user generated study guides or outlines, or a combination of two or more thereof. In one embodiment, in the above system the at least one user created data packet is selected from class notes, lecture notes, lab notes, lab data, class related diagrams and/or pictures, user generated study guides or outlines, or a combination of two or more thereof. In one embodiment, in the above system the at least one World Wide Web site is designed to receive the at least one user created data packet further comprises a notification system designed to notify one or more individuals when one or more one user created data packets are posted to the at least one World Wide Web site. In one embodiment, in the above system the notification occurs via Twitter, Facebook, MySpace, or a combination of two or more thereof.

In another embodiment, the systems and/or methods of the present invention are executed, run and/or utilized on a web-connected electronic device (e.g., a personal computer) comprising, among other necessary components as known to those of skill in the art, a power supply, a display, an operating system, at least one processor and related hardware, one or more types of memory. In this embodiment, the systems of the present invention rely in part, or in whole, on an application or web-based interface that is designed to run on dedicated computer program, or in a suitable computer program (e.g., a suitable web browser or other type of web-based application or interface, or even an application designed to run on any web-enabled electronic device such as an Android application or Apple application).

In another embodiment, the systems and/or methods of the present invention permit an increase in student performance due to the ability of a student, if so motivated, to interact with a wider range and number of students in order to better enhance a student's ability to learn to course material in question. In one instance, the systems and/or methods of the present invention permit a student to interact with one or more geographically remote students who are studying the same, or similar, material, taking and/or participating in the same, or similar, class, etc. Thus, in one embodiment, the systems and/or methods of the present invention as described above, act as a social networking site designed specifically to permit a student to exchange, purchase, and/or sell course student-prepared related materials and/or ideas with one or more students regardless of geographical proximity.

Although the invention has been shown and described with respect to certain embodiments, it is obvious that equivalent alterations and modifications will occur to others skilled in the art upon the reading and understanding of this specification. In particular with regard to the various functions performed by the above described components, the terms (including any reference to a “means”) used to describe such components are intended to correspond, unless otherwise indicated, to any component which performs the specified function of the described component (e.g., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more other features of the other embodiments as may be desired and advantageous for any given or particular application.

1. A system for permitting the posting of user generated content to the World Wide Web, the system comprising:
at least one web-enabled electronic device;
at least one program application, wherein the program application is designed to run on the at least one web-enabled electronic device and access the World Wide Web therefrom;
at least one user created data packet, wherein the at least one user created data packet is located in the memory at least one web-enabled electronic device or is electronically accessible to the at least one web-enabled electronic device; and
at least one World Wide Web site designed to receive the at least one user created data packet, wherein the at least one World Wide Web site is designed to permit searching of all of the user created data packets thereon by one or more criteria selected from author's name, subject matter, class name, class number, class section number, professor's name, college, ISBN number, text book title, text book author's name, text book editor's name, text book publisher, or any two or more thereof.

2. The system of claim 1, wherein the at least one web-enabled electronic device is selected from a computer, a tablet, a cell phone, a personal digital assistant (PDA), or a WI-FI enabled device.

3. The system of claim 1, wherein the at least one program application is selected from a web browser, an Apple application, an Android application, or a combination of two or more thereof.

4. The system of claim 1, wherein the at least one user created data packet is selected from PDF files, word processing files, gif files/images, jpeg files/images, tiff files/images, or a combination of two or more thereof.

5. (canceled)

6. The system of claim 1, wherein the at least one user created data packet is selected from class notes, lecture notes, lab notes, lab data, class related diagrams and/or pictures, user generated study guides or outlines, or a combination of two or more thereof.

7. The system of claim 1, wherein the at least one World Wide Web site is designed to receive the at least one user created data packet further comprises a purchase system designed to permit an individual to purchase one or more user created data packets from the at least one World Wide Web site.

8. The system of claim 7, wherein the at least one World Wide Web site retains at least about 5 percent of a pre-set sale price that is set by the user/content creator with the remainder being forwarded to the user/content creator.

9. (canceled)

10. (canceled)

11. (canceled)

12. (canceled)

13. The system of claim 1, wherein the at least one World Wide Web site is designed to receive the at least one user created data packet further comprises a notification system designed to notify one or more individuals when one or more one user created data packets are posted to the at least one World Wide Web site.

14. The system of claim 13, wherein the notification occurs via Twitter, Facebook, MySpace, or a combination of two or more thereof.

15. A method for permitting the posting of user generated content to the World Wide Web, the method comprising the steps of:
providing at least one web-enabled electronic device;
providing at least one program application, wherein the program application is designed to run on the at least one web-enabled electronic device and access the World Wide Web therefrom;
providing at least one World Wide Web site designed to receive at least one user created data packet, wherein the at least one World Wide Web site is designed to permit searching of all of the user created data packets thereon by one or more criteria selected from author's name, subject matter, class name, class number, class section number, professor's name, college, ISBN number, text book title, text book author's name, text book editor's name, text book publisher, or any two or more thereof;
accessing the at least one World Wide Web site via the at least one web-enabled electronic device; and
posting at least one user created data packet to the at least one World Wide Web site, wherein the at least one user created data packet is located in the memory at least one web-enabled electronic device or is electronically accessible to the at least one web-enabled electronic device.

16. The method of claim 15, wherein the at least one web-enabled electronic device is selected from a computer, a tablet, a cell phone, a personal digital assistant (PDA), or a WI-FI enabled device.

17. The method of claim 15, wherein the at least one program application is selected from a web browser, an Apple application, an Android application, or a combination of two or more thereof.

18. The method of claim 15, wherein the at least one user created data packet is selected from PDF files, word processing files, gif files/images, jpeg files/images, tiff files/images, or a combination of two or more thereof.

19. (canceled)

20. The method of claim 15, wherein the at least one user created data packet is selected from class notes, lecture notes, lab notes, lab data, class related diagrams and/or pictures, user generated study guides or outlines, or a combination of two or more thereof.

21. The method of claim 15, wherein the method further comprises the step of:
setting a sale price for the at least one user created data packet, wherein the sale prices is determined by the user/content creator.

22. The method of claim 15, wherein the at least one World Wide Web site is designed to receive the at least one user created data packet further comprises a purchase system designed to permit an individual to purchase one or more user created data packets from the at least one World Wide Web site.

23. The method of claim 22, wherein the at least one World Wide Web site retains at least about 5 percent of the pre-set sale price that is set by the user/content creator with the remainder being forwarded to the user/content creator.

24. (canceled)

25. (canceled)

26. (canceled)

27. (canceled)

28. The method of claim 15, wherein the at least one World Wide Web site is designed to receive the at least one user created data packet further comprises a notification system designed to notify one or more individuals when one or more one user created data packets are posted to the at least one World Wide Web site.

29. The method of claim 28, wherein the notification occurs via Twitter, Facebook, MySpace, or a combination of two or more thereof.

30. A system for permitting the transfer and/or purchase of user generated content to the World Wide Web, the system comprising:
at least one web-enabled electronic device;
at least one program application, wherein the program application is designed to run on the at least one web-enabled electronic device and access the World Wide Web therefrom;
at least one user created data packet, wherein the at least one user created data packet is located in the memory at least one web-enabled electronic device or is electronically accessible to the at least one web-enabled electronic device; and
at least one World Wide Web site designed to receive, store and transfer the at least one user created data packet, wherein the at least one World Wide Web site is designed to permit searching of all of the user created data packets thereon by one or more criteria selected from author's name, subject matter, class name, class number, class section number, professor's name, college, ISBN number, text book title, text book author's name, text book editor's name, text book publisher, or any two or more thereof,
wherein the at least one World Wide Web site further comprises a payment processing system designed to process payments for the at least one user created data packet and a system for permitting the transfer of the user created data packet to at least one purchaser.

31. The system of claim 30, wherein the at least one web-enabled electronic device is selected from a computer, a tablet, a cell phone, a personal digital assistant (PDA), or a WI-FI enabled device.

32. The system of claim 30, wherein the at least one program application is selected from a web browser, an Apple application, an Android application, or a combination of two or more thereof.

33. The system of claim 30, wherein the at least one user created data packet is selected from PDF files, word processing files, gif files/images, jpeg files/images, tiff files/images, or a combination of two or more thereof.

34. (canceled)

35. The system of claim 30, wherein the at least one user created data packet is selected from class notes, lecture notes, lab notes, lab data, class related diagrams and/or pictures, user generated study guides or outlines, or a combination of two or more thereof.

36. The system of claim 30, wherein the at least one World Wide Web site is designed to receive the at least one user created data packet further comprises a purchase system designed to permit an individual to purchase one or more user created data packets from the at least one World Wide Web site.

37. The system of claim 36, wherein the at least one World Wide Web site retains at least about 5 percent of a pre-set sale price that is set by the user/content creator with the remainder being forwarded to the user/content creator.

38. (canceled)

39. (canceled)

40. (canceled)

41. (canceled)

42. The system of claim 30, wherein the at least one World Wide Web site is designed to receive the at least one user created data packet further comprises a notification system designed to notify one or more individuals when one or more one user created data packets are posted to the at least one World Wide Web site.

43. The system of claim 42, wherein the notification occurs via Twitter, Facebook, MySpace, or a combination of two or more thereof.

44. A method for permitting the transfer and/or purchase of user generated content to the World Wide Web, the method comprising the steps of:
providing at least one web-enabled electronic device;
providing at least one program application, wherein the program application is designed to run on the at least one web-enabled electronic device and access the World Wide Web therefrom;
providing at least one World Wide Web site designed to receive at least one user created data packet, wherein the at least one World Wide Web site is designed to permit searching of all of the user created data packets thereon by one or more criteria selected from author's name, subject matter, class name, class number, class section number, professor's name, college, ISBN number, text book title, text book author's name, text book editor's name, text book publisher, or any two or more thereof;
accessing the at least one World Wide Web site via the at least one web-enabled electronic device;
searching the one or more user created data packets; and
purchasing at least one or more user created data packets.

45. The method of claim 44, wherein the at least one web-enabled electronic device is selected from a computer, a tablet, a cell phone, a personal digital assistant (PDA), or a WI-FI enabled device.

46. The method of claim 44, wherein the at least one program application is selected from a web browser, an Apple application, an Android application, or a combination of two or more thereof.

47. The method of claim 44, wherein the at least one user created data packet is selected from PDF files, word processing files, gif files/images, jpeg files/images, tiff files/images, or a combination of two or more thereof.

48. (canceled)

49. The method of claim 44, wherein the at least one user created data packet is selected from class notes, lecture notes, lab notes, lab data, class related diagrams and/or pictures, user generated study guides or outlines, or a combination of two or more thereof.

50. The method of claim 44, wherein the at least one World Wide Web site is designed to receive the at least one user created data packet further comprises a notification system designed to notify one or more individuals when one or more one user created data packets are posted to the at least one World Wide Web site.

51. The method of claim 50, wherein the notification occurs via Twitter, Facebook, MySpace, or a combination of two or more thereof.
